(19) United States
(12) Patent Application Publication
(10) Pub. No.: US 2026/0252503 A1
(43) Pub. Date: Aug. 27, 2026

(54) COMPUTING SYSTEM INCLUDING STORAGE DEVICE AND OPERATING METHOD THEREOF

(71) Applicant: SK hynix Inc., Icheon-si (KR)

(72) Inventor: Min Ho HA, Icheon-si (KR)

(21) Appl. No.: 19/300,438

(22) Filed: Aug. 14, 2025

(30) Foreign Application Priority Data
Feb. 21, 2025 (KR) 10-2025-0022900

(51) Int. Cl. G06F 13/16

(52) U.S. Cl. CPC G06F 13/1668; G06F 13/1663

(57) ABSTRACT

A storage device includes a shared memory and a memory controller. The shared memory stores first data received from a first computing node and second data received from a second computing node. The memory controller performs an instruction on the first data and the second data, stores third data, which is a result of performing the instruction, in the shared memory, and transmits the third data to the first computing node and the second computing node.

### CROSS-REFERENCE TO RELATED APPLICATION

The present application claims priority under 35 U.S.C. §119(a) to Korean patent application number 10-2025-0022900, filed on February 21, 2025, in the Korean Intellectual Property Office, the entire disclosure of which is incorporated herein by reference.

### BACKGROUND

### Technical Field

Various embodiments of the present disclosure generally relate to an electronic device, and more particularly, to a computing system and an operating method thereof.

### Related Art

In a cluster environment which includes a plurality of computing nodes, data may be processed in parallel at respective computing nodes for efficient data processing. The respective computing nodes may communicate with each other and perform data processing based on a Message Passing Interface (MPI).

### SUMMARY

Various embodiments of the present disclosure are directed to a computing system including a plurality of computing nodes and processing an MPI operation by utilizing shared memory and a Near Data Processing (NDP) engine, and an operating method thereof.

A storage device according to an embodiment of the present disclosure may include a shared memory and a memory controller. The shared memory may store first data received from a first computing node and second data received from a second computing node. The memory controller may perform an instruction on the first data and the second data, may store third data, which is a result of performing the instruction, in the shared memory, and may transmit the third data to the first computing node and the second computing node.

A computing system according to an embodiment of the present disclosure may include a plurality of computing nodes and a storage device. The storage device may receive input data including data corresponding to each of the plurality of computing nodes from the plurality of computing nodes, may perform an instruction on the input data, and may transmit output data which is a result of performing the instruction to the plurality of computing nodes.

A method of operating a storage device including a shared memory according to an embodiment of the present disclosure may include receiving first data from a first computing node and receiving second data from a second computing node; storing the first data and the second data in the shared memory; performing an instruction on the first data and the second data; and storing third data, which is a result of performing the instruction, in the shared memory.

### BRIEF DESCRIPTION OF THE DRAWINGS

FIG. 1 is a diagram illustrating a computing system according to an embodiment of the present disclosure.

FIGS. 2A and 2B are diagrams illustrating an MPI operation performed in a computing system of FIG. 1.

FIG. 3 is a diagram illustrating an MPI operation performed in a computing system of FIG. 1.

FIG. 4 is a diagram illustrating a computing system according to an embodiment of the present disclosure.

FIGS. 5A and 5B are diagrams illustrating an MPI operation performed in a computing system of FIG. 4.

FIG. 6 is a diagram illustrating a method of operating a storage device according to an embodiment of the present disclosure.

FIG. 7 is a diagram illustrating a method of operating a computing system according to an embodiment of the present disclosure.

### DETAILED DESCRIPTION

Specific structural or functional descriptions disclosed herein are merely illustrative for the purpose of describing embodiments according to the concepts of the present disclosure. However, embodiments according to the concepts of the present disclosure may be implemented in various forms and should not be construed as being limited to the specific embodiments set forth herein.

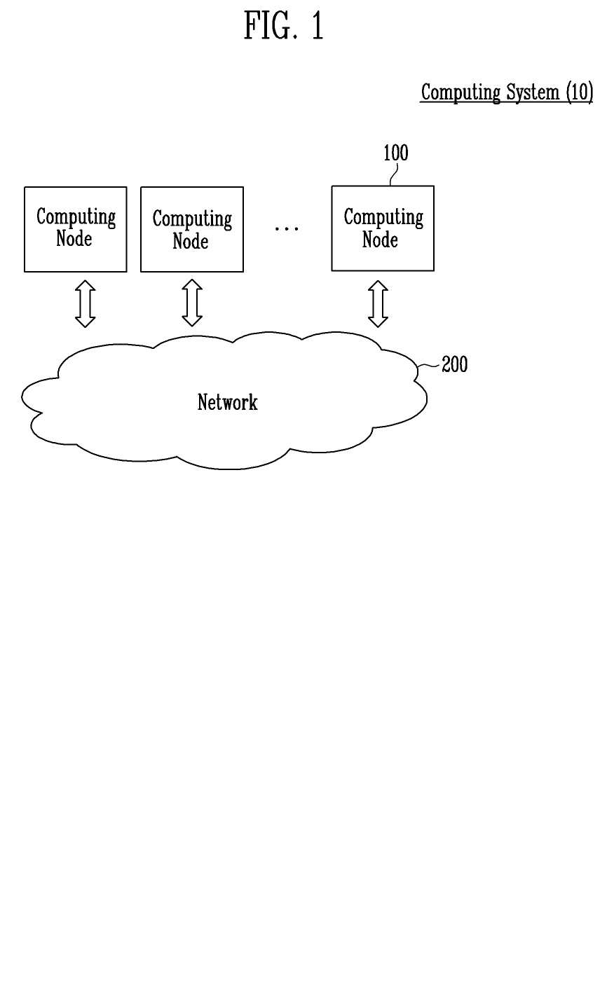

FIG. 1 is a diagram illustrating a computing system according to an embodiment of the present disclosure.

Referring to FIG. 1, a computing system 10 may include a plurality of computing nodes 100 and a network 200.

The plurality of computing nodes 100 may communicate with each other using a Message Passing Interface (MPI) on the network 200. The MPI may be a library that enables communication and synchronization between the computing nodes 100 via the network 200.

MPI operations (i.e., operations using an MPI) may include point-to-point communication, collective communication, synchronization, data partitioning and aggregation, an asynchronous operation, environment initialization and management, and the like.

Point-to-point communication may be an operation in which one computing node 100 sends or receives data to another computing node 100 (i.e., MPI_Send, MPI_Recv). Collective communication may be an operation in which multiple computing nodes 100 reduce or broadcast data (i.e., MPI_Reduce, MPI_Bcast). Synchronization may be an operation that synchronizes a state of operations across all computing nodes 100 to ensure the performance of aligned operations at a specific point in time (i.e., MPI_Barrier). Data partitioning and aggregation may be an operation of dividing data into task units, processing the divided data in parallel, and aggregating the results upon completion of the processing. An asynchronous operation may be an operation of supporting asynchronous data transfer to reduce network latency and increase work efficiency (i.e., MPI_Isend, MPI_Irecv). Environment initialization and management may be an operation of managing a process rank and the number of computing nodes, and initializing and finalizing an MPI environment (i.e., MPI_Init, MPI_Finalize).

The above-described operations may help high-performance computing (HPC) optimize parallel processing of data and effectively perform large-scale distributed operations.

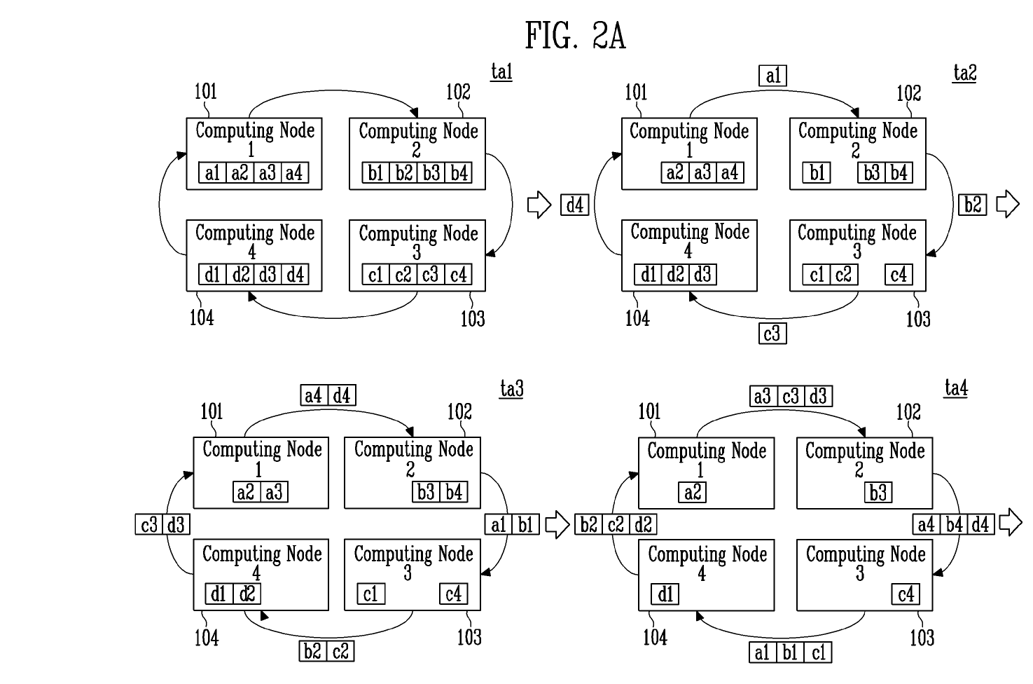

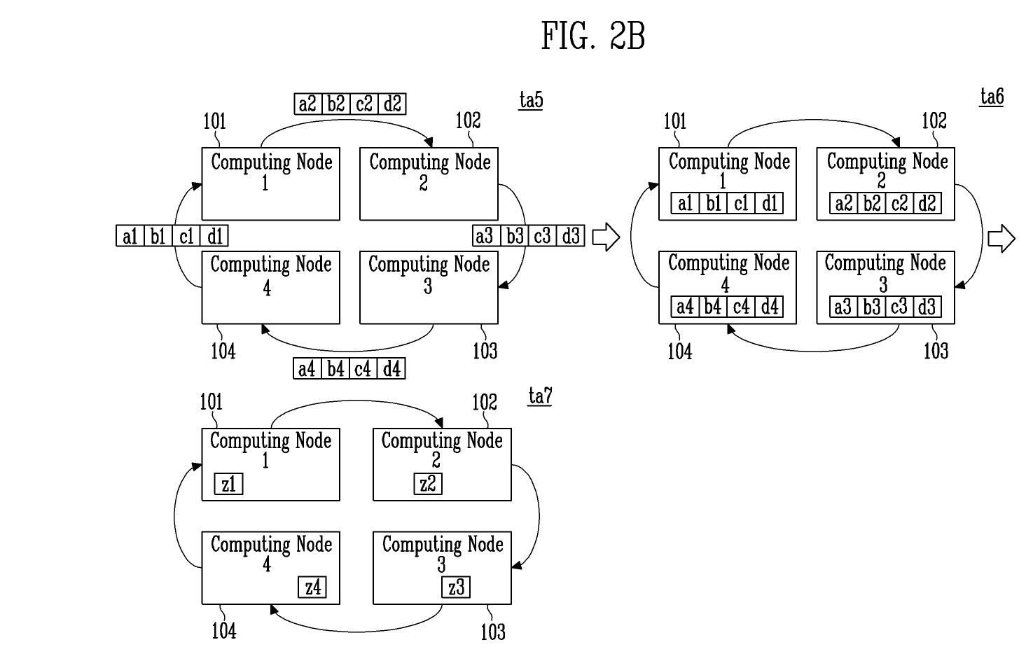

FIGS. 2A and 2B are diagrams illustrating an MPI operation performed in a computing system of FIG. 1.

Referring to FIGS. 2A and 2B, processes associated with an MPI operation among first to fourth computing nodes 101 to 104 are illustrated.

In a process ta1, a first computing node 101 stores a1 to a4 data, and the a1 to a4 data may be application data of the first computing node 101. The second computing node 102 stores b1 to b4 data, and the b1 to b4 data may be application data of the second computing node 102. The third computing node 103 stores c1 to c4 data, and the c1 to c4 data may be application data of the third computing node 103. The fourth computing node 104 stores d1 to d4 data, and the d1 to d4 data may be application data of the fourth computing node 104.

Through processes from ta1 to ta7, the application data of each computing node may be aggregated and specific operations may be performed.

For example, in a process ta2, the first computing node 101 may transmit the a1 data to the second computing node 102 and receive the d4 data from the fourth computing node 104. The second computing node 102 may transmit the b2 data to the third computing node 103 and receive the a1 data from the first computing node 101. The third computing node 103 may transmit the c3 data to the fourth computing node 104 and receive the b2 data from the second computing node 102. The fourth computing node 104 may transmit the d4 data to the first computing node 101 and receive the c3 data from the third computing node 103.

In a process ta3, the first computing node 101 may transmit the a4 and d4 data to the second computing node 102 and receive the c3 and d3 data from the fourth computing node 104. The second computing node 102 may transmit the a1 and b1 data to the third computing node 103 and receive the a4 and d4 data from the first computing node 101. The third computing node 103 may transmit the b2 and c2 data to the fourth computing node 104 and receive the a1 and b1 data from the second computing node 102. The fourth computing node 104 may transmit the c3 and d3 data to the first computing node 101 and receive the b2 and c2 data from the third computing node 103.

In a process ta4, the first computing node 101 may transmit the a3, c3, and d3 data to the second computing node 102 and receive the b2, c2, and d2 data from the fourth computing node 104. The second computing node 102 may transmit the a4, b4, and d4 data to the third computing node 103 and receive the a3, c3, and d3 data from the first computing node 101. The third computing node 103 may transmit the a1, b1, and c1 data to the fourth computing node 104 and receive the a4, b4, and d4 data from the second computing node 102. The fourth computing node 104 may transmit the b2, c2, and d2 data to the first computing node 101 and receive the a1, b1, and c1 data from the third computing node 103.

In a process ta5, the first computing node 101 may transmit the a2, b2, c2, and d2 data to the second computing node 102 and receive the a1, b1, c1, and d1 data from the fourth computing node 104. The second computing node 102 may transmit the a3, b3, c3, and d3 data to the third computing node 103 and receive the a2, b2, c2, and d2 data from the first computing node 101. The third computing node 103 may transmit the a4, b4, c4, and d4 data to the fourth computing node 104 and receive the a3, b3, c3, and d3 data from the second computing node 102. The fourth computing node 104 may transmit the a1, b1, c1, and d1 data to the first computing node 101 and receive the a4, b4, c4, and d4 data from the third computing node 103.

In a process ta6, the first computing node 101 may have the a1, b1, c1, and d1 data. The second computing node 102 may have the a2, b2, c2, and d2 data. The third computing node 103 may have the a3, b3, c3, and d3 data. The fourth computing node 104 may have the a4, b4, c4, and d4 data.

Through the processes from ta1 to ta6, application data distributed to the respective computing nodes may be redistributed to the respective computing nodes.

In a process ta7, an MPI operation may be performed on the data redistributed to each computing node. During the MPI operation, each computing node may perform an operation including at least one of Max, Min, Sum, Multiply, AND, OR, Bitwise AND, or Bitwise OR operation.

For example, the first computing node 101 may perform an MPI operation on the a1, b1, c1, and d1 data and obtain z1 data. The second computing node 102 may perform an MPI operation on the a2, b2, c2, and d2 data and obtain z2 data. The third computing node 103 may perform an MPI operation on the a3, b3, c3, and d3 data and obtain z3 data. The fourth computing node 104 may perform an MPI operation on the a4, b4,c4, and d4 data and obtain z4 data.

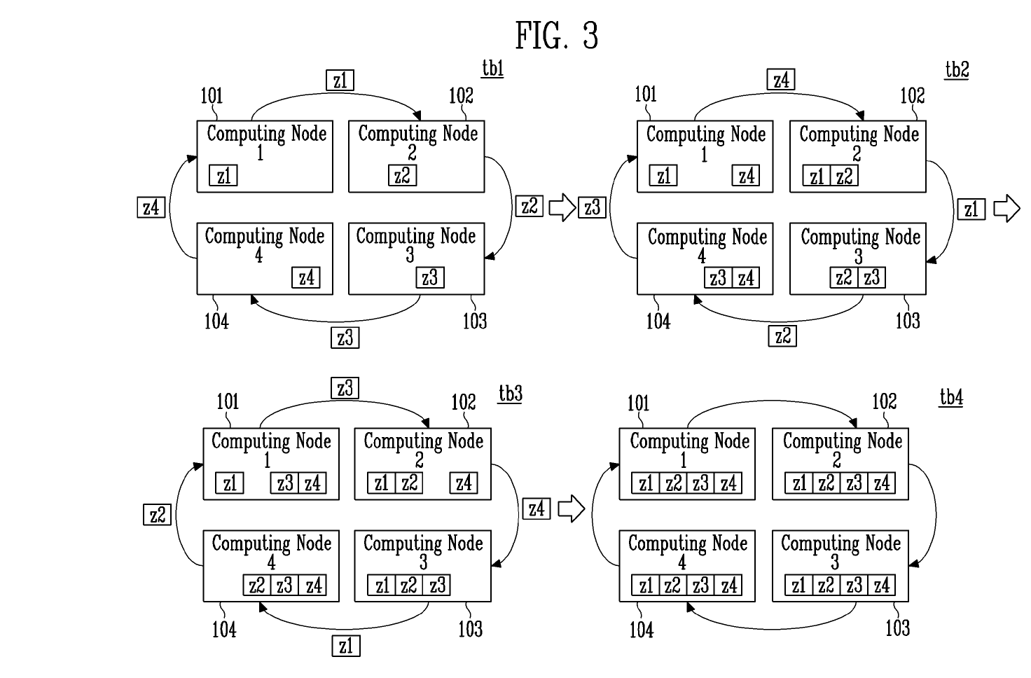

FIG. 3 is a diagram illustrating an MPI operation performed in a computing system of FIG. 1.

Referring to FIG. 3, processes in which each computing node shares data obtained after performing an MPI operation with another computing node through processes from tb1 to tb4 may be described.

For example, in the process tb1, the first computing node 101 may transmit the z1 data to the second computing node 102. The second computing node 102 may transmit the z2 data to the third computing node 103. The third computing node 103 may transmit the z3 data to the fourth computing node 104. The fourth computing node 104 may transmit the z4 data to the first computing node 101.

In the process tb2, the first computing node 101 may transmit the z4 data to the second computing node 102. The second computing node 102 may transmit the z1 data to the third computing node 103. The third computing node 103 may transmit the z2 data to the fourth computing node 104. The fourth computing node 104 may transmit the z3 data to the first computing node 101.

In the process tb3, the first computing node 101 may transmit the z3 data to the second computing node 102. The second computing node 102 may transmit the z4 data to the third computing node 103. The third computing node 103 may transmit the z1 data to the fourth computing node 104. The fourth computing node 104 may transmit the z2 data to the first computing node 101.

In the process tb4, all of the first to fourth computing nodes 101 to 104 may equally have the z1 to z4 data.

Through the processes from tb1 to tb4, each computing node may share the operation result it has performed with another computing node and receive the operation result from another computing node. As such, parallel processing of data may be performed at each computing node.

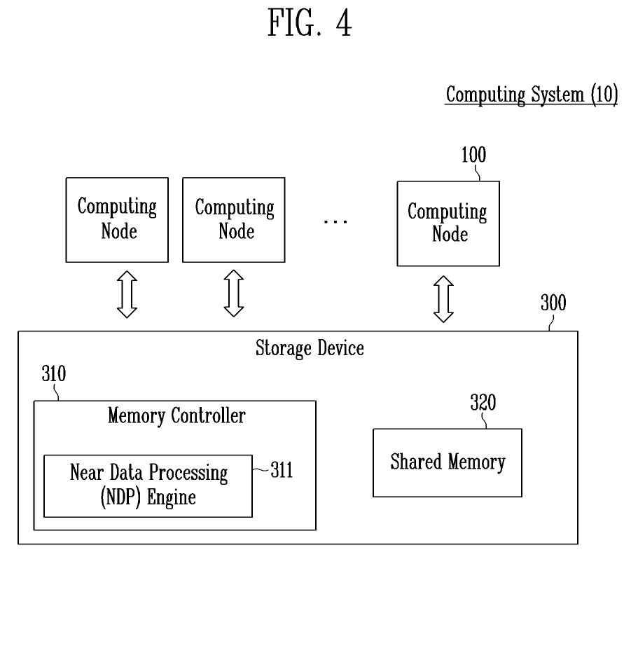

FIG. 4 is a diagram illustrating a computing system according to an embodiment of the present disclosure.

Referring to FIG. 4, a computing system 10 may include a plurality of computing nodes 100 and a storage device 300.

The storage device 300 may be a device storing data, and may include volatile memory and non-volatile memory. Volatile memory may include Static Random Access Memory (SRAM) or Dynamic RAM (DRAM). Non-volatile memory may include a Solid State Drive (SSD), a hard disk, a multimedia card in the form of a MultiMedia card (MMC), an embedded MMC (eMMC), a Universal Serial Bus (USB) storage device, a Universal Flash Storage (UFS) device, a Peripheral Component Interconnect (PCI), a PCI Express (PCI-e) card type storage device, or the like.

The storage device 300 may communicate with the computing node 100 using at least one of various communication methods such as Universal Serial Bus (USB), Serial AT Attachment (SATA), Serial Attached SCSI (SAS), High Speed Interchip (HSIC), Small Computer System Interface (SCSI), Peripheral Component Interconnect (PCI), PCI Express (PCI-e), NonVolatile Memory express (NVMe), Universal Flash Storage (UFS), Secure Digital (SD), MultiMedia Card (MMC), embedded MMC (eMMC), Dual In-line Memory Module (DIMM), Registered DIMM (RDIMM), and Load Reduced DIMM (LRDIMM) communication methods.

In an embodiment, the storage device 300 may include a memory controller 310 and a shared memory 320.

The memory controller 310 may communicate with the plurality of computing nodes 100. For example, the memory controller 310 may communicate with the plurality of computing nodes 100 via a Compute Express Link (CXL) interface. The memory controller 310 may be a controller which controls a CXL memory device.

The memory controller 310 may receive input data, including data corresponding to each of the plurality of computing nodes 100, from the plurality of computing nodes 100. The input data may include application data corresponding to each of the plurality of computing nodes 100.

The memory controller 310 may store the input data in the shared memory 320 and perform an instruction on the input data. The memory controller 310 may store output data, which is the result of performing the instruction, in the shared memory 320, and transmit the output data to the plurality of computing nodes 100.

The shared memory 320 may be memory which is shared and accessed by the plurality of computing nodes 100. In an embodiment, the shared memory 320 may be pooled memory.

The memory controller 310 may include a Near Data Processing (NDP) engine 311. The NDP engine 311 may perform the instruction on the input data stored in the shared memory 320 based on a Message Passing Interface (MPI) protocol. The NDP engine 311 may perform an operation including at least one of Max, Min, Sum, Multiply, AND, OR, Bitwise AND, or Bitwise OR operation in the instruction. The NDP engine 311 may store the output data, which is the result of performing the instruction, in the shared memory 320.

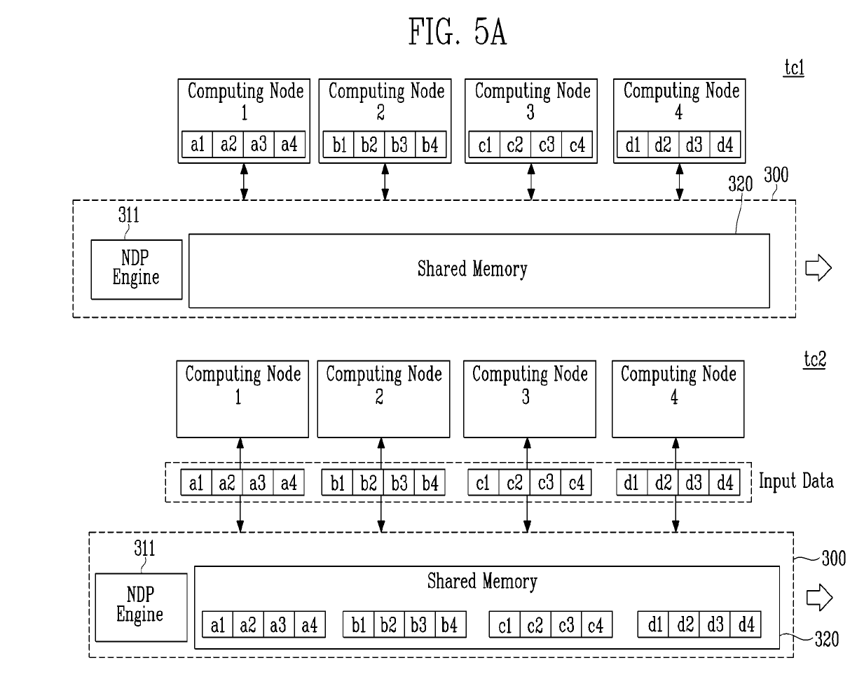

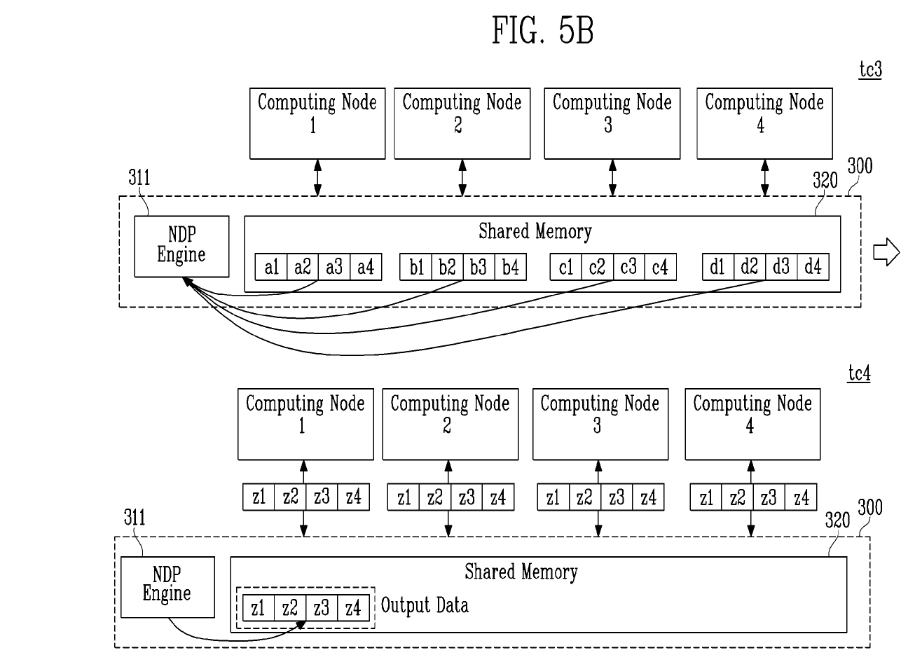

FIGS. 5A and 5B are diagrams illustrating an MPI operation performed in a computing system of FIG. 4.

Referring to FIGS. 5A and 5B, an MPI operation process of first to fourth computing nodes 101 to 104 via a storage device 300 may be described.

For example, in a process tc1, the first computing node 101 stores the a1 to a4 data, and the a1 to a4 data may be application data of the first computing node 101. The second computing node 102 stores the b1 to b4 data, and the b1 to b4 data may be application data of the second computing node 102. The third computing node 103 stores the c1 to c4 data, and the c1 to c4 data may be application data of the third computing node 103. The fourth computing node 104 stores the d1 to d4 data, and the d1 to d4 data may be application data of the fourth computing node 104.

In a process tc2, the storage device 300 may receive the a1 to a4 data from the first computing node 101, the b1 to b4 data from the second computing node 102, the c1 to c4 data from the third computing node 103, and the d1 to d4 data from the fourth computing node 104.

The shared memory 320 may store input data including the a1 to a4, b1 to b4, c1 to c4, and d1 to d4 data received from the respective computing nodes.

In a process tc3, the NDP engine 311 may perform an instruction on the input data stored in the shared memory 320. The NDP engine 311 may perform an operation including at least one of Max, Min, Sum, Multiply, AND, OR, Bitwise AND, or Bitwise OR operation on the input data in the instruction.

In a process tc4, the NDP engine 311 may store output data, which is the result of performing the instruction, in the shared memory 320. The output data may include the z1 to z4 data. The storage device 300 may transmit the output data to each computing node.

Compared to an MPI operation described with reference to FIGS. 2A, 2B, and 3, an MPI operation described with reference to FIGS. 5A and 5B utilizes the shared memory 320 and the NDP engine 311, so that overhead due to unnecessary data movement and copying may be reduced.

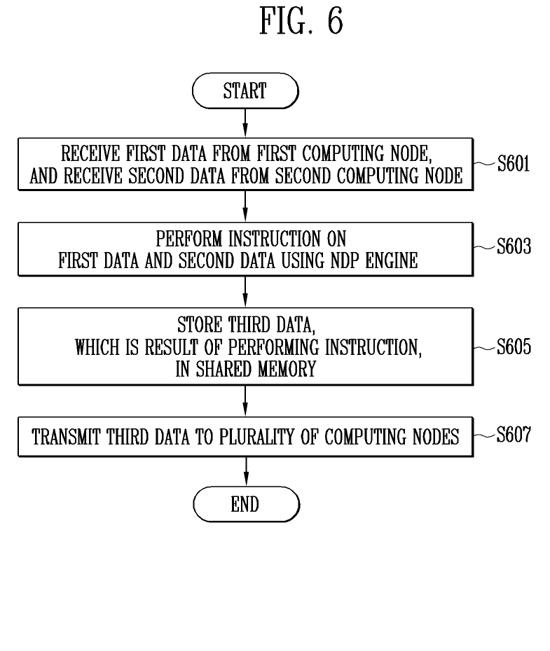

FIG. 6 is a diagram illustrating a method of operating a storage device according to an embodiment of the present disclosure.

Referring to FIG. 6, in step S601, a storage device may receive first data from a first computing node and receive second data from a second computing node. The first data may be application data of the first computing node, and the second data may be application data of the second computing node.

In step S603, the storage device may perform an instruction on the first data and the second data by using a Near Data Processing (NDP) engine. The instruction may be performed based on a Message Passing Interface (MPI) protocol.

In step S605, the storage device may store third data, which is the result of performing the instruction, in a shared memory.

In step S607, the storage device may transmit the third data to a plurality of computing nodes.

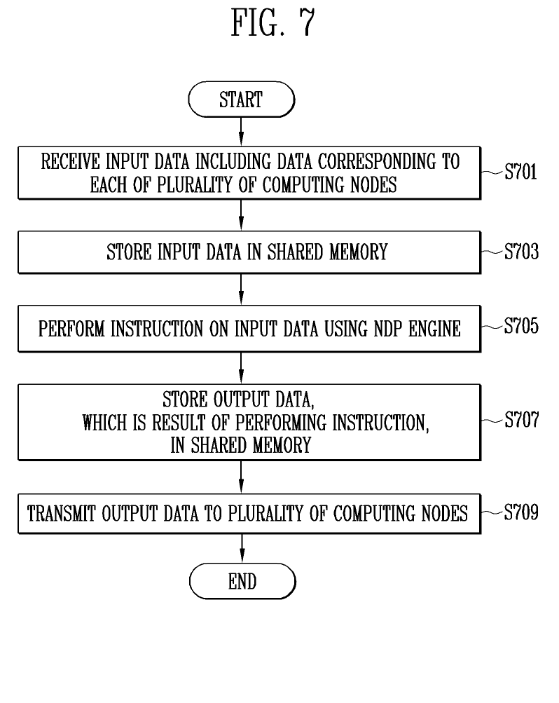

FIG. 7 is a diagram illustrating a method of operating a computing system according to an embodiment of the present disclosure.

Referring to FIG. 7, in step S701, a computing system may receive input data including data corresponding to each of a plurality of computing nodes.

In step S703, the computing system may store the input data in a shared memory.

In step S705, the computing system may perform an instruction on the input data using a Near Data Processing (NDP) engine.

In step S707, the computing system may store output data, which is the result of performing the instruction, in the shared memory.

In step S709, the computing system may transmit the output data to the plurality of computing nodes.

According to some embodiments of the present disclosure, a computing system including a plurality of computing nodes and processing an MPI operation by utilizing a shared memory and a Near Data Processing (NDP) engine, and an operating method thereof are provided.

What is claimed is:

1. A storage device, comprising:
a shared memory storing first data received from a first computing node and second data received from a second computing node; and
a memory controller configured to:
perform an instruction on the first data and the second data;
store third data, which is a result of performing the instruction, in the shared memory; and
transmit the third data to the first computing node and the second computing node.

2. The storage device of claim 1, wherein the first data is application data corresponding to the first computing node, and
wherein the second data is application data corresponding to the second computing node.

3. The storage device of claim 1, wherein the memory controller communicates with the first computing node and the second computing node via a Compute Express Link (CXL) interface.

4. The storage device of claim 1, wherein the memory controller performs the instruction based on a Message Passing Interface (MPI) protocol.

5. The storage device of claim 1, wherein the memory controller includes a Near Data Processing (NDP) engine performing the instruction on the first data and the second data.

6. The storage device of claim 1, wherein the memory controller performs an operation including at least one of Max, Min, Sum, Multiply, AND, OR, Bitwise AND, or Bitwise OR operation in the instruction.

7. A computing system, comprising:
a plurality of computing nodes; and
a storage device configured to:
receive input data including data corresponding to each of the plurality of computing nodes from the plurality of computing nodes;
perform an instruction on the input data; and
transmit output data which is a result of performing the instruction to the plurality of computing nodes.

8. The computing system of claim 7, wherein the input data includes application data corresponding to each of the plurality of computing nodes.

9. The computing system of claim 7, wherein the storage device communicates with the plurality of computing nodes via a Compute Express Link (CXL) interface.

10. The computing system of claim 7, wherein the storage device performs the instruction based on a Message Passing Interface (MPI) protocol.

11. The computing system of claim 7, wherein the storage device includes a Near Data Processing (NDP) engine performing the instruction on the input data.

12. The computing system of claim 7, wherein the storage device includes a shared memory shared by the plurality of computing nodes and storing the input data.

13. The computing system of claim 7, wherein the storage device performs an operation including at least one of Max, Min, Sum, Multiply, AND, OR, Bitwise AND, or Bitwise OR operation in the instruction.

14. A method of operating a storage device including a shared memory, the method comprising:
receiving first data from a first computing node and second data from a second computing node;
storing the first data and the second data in the shared memory;
performing an instruction on the first data and the second data; and
storing third data, which is a result of performing the instruction, in the shared memory.

15. The method of claim 14, further comprising transmitting the third data to the first computing node and the second computing node.

16. The method of claim 14, wherein the first data is application data corresponding to the first computing node, and
wherein the second data is application data corresponding to the second computing node.

17. The method of claim 14, wherein the storage device communicates with the first computing node and the second computing node via a Compute Express Link (CXL) interface.

18. The method of claim 14, wherein the instruction is performed based on a Message Passing Interface (MPI) protocol.

19. The method of claim 14, wherein the instruction is performed by a Near Data Processing (NDP) engine of the storage device.

20. The method of claim 14, wherein performing the instruction includes performing an operation including at least one of Max, Min, Sum, Multiply, AND, OR, Bitwise AND, or Bitwise OR operation on the first data and the second data.
